(19) United States
(12) Patent Application Publication
(10) Pub. No.: US 2025/0008373 A1
(43) Pub. Date: Jan. 2, 2025

(54) WIRELESS COMMUNICATION METHOD, AND DEVICE

(71) Applicant: GUANGDONG OPPO MOBILE TELECOMMUNICATIONS CORP., LTD., Dongguan (CN)

(72) Inventors: Yali GUO, Dongguan (CN); Boren GUO, Dongguan (CN)

(21) Appl. No.: 18/882,061

(22) Filed: Sep. 11, 2024

Related U.S. Application Data
(63) Continuation of application No. PCT/CN2022/080966, filed on Mar. 15, 2022.

(51) Int. Cl. H04W 28/06; H04L 5/00; H04L 69/22; H04W 80/04

(52) U.S. Cl. CPC H04W 28/06; H04L 5/0048; H04L 69/22; H04W 80/04

(57) ABSTRACT

A method for wireless communication is applicable to a first core network device and includes: determining information of a reference data set for a target data set, wherein the target data set comprises at least one first data packet; acquiring at least one second data packet by adding the information of the reference data set to a packet header other than an Internet Protocol (IP) packet header of the at least one first data packet; and transmitting the at least one second data packet to an access network device.

### CROSS-REFERENCE TO RELATED APPLICATION

This application is a continuation application of International Application No. PCT/CN2022/080966, filed on Mar. 15, 2022, the entire disclosure of which is hereby incorporated herein by reference.

### TECHNICAL FIELD

Embodiments of the present disclosure relate to the technical field of communications, and in particular, relate to a method for wireless communication, and a device thereof.

### BACKGROUND

In video transmission scenarios such as augmented reality (AR), virtual reality (VR), or cloud gaming, video coding techniques are involved. The video coding techniques typically include coding techniques based on intra-frame prediction and inter-frame prediction. Based on this, currently, intra-coded frames (I-frames), forward prediction-coded frames (P-frames), and bi-directional interpolated prediction-coded frames (B-frames) are defined. It can be thus understood that a dependency relationship is present between video frames. For example, a reference frame for a P-frame is a previous I-frame or P-frame thereof.

### SUMMARY

Embodiments of the present disclosure provide a method for wireless communication, and a device thereof.

According to some embodiments of the present disclosure, a method for wireless communication is provided. The method is applicable to a first core network device. The method includes: determining information of a reference data set for a target data set, wherein the target data set includes at least one first data packet; acquiring at least one second data packet by adding the information of the reference data set to a packet header other than an Internet Protocol (IP) packet header of the at least one first data packet; and transmitting the at least one second data packet to an access network device.

According to some embodiments of the present disclosure, a core network device is provided. The core network device is a first core network device and includes a processor and a memory. The memory is configured to store one or more computer programs. The processor, when loading and running the one or more computer programs stored in the memory, is caused to perform the method described above.

According to some embodiments of the present disclosure, a core network device is provided. The core network device is a second core network device and includes a processor and a memory. The memory is configured to store one or more computer programs. The processor, when loading and running the one or more computer programs stored in the memory, is caused to perform: transmitting a first indication to a first core network device, wherein the first indication is used for the first core network device to perform: determining the information of the reference data set based on the first indication, and/or acquiring the at least one second data packet by adding the information of the reference data set to the packet header other than the IP packet header of the at least one first data packet based on the first indication.

### BRIEF DESCRIPTION OF THE DRAWINGS

FIG. 1 exemplarily illustrates a schematic diagram of a communication system 100 to which the present disclosure is applicable;

FIG. 2 exemplarily illustrates a schematic diagram of a user plane protocol stack;

FIG. 3 is an interaction flowchart of a method for wireless communication according to some embodiments of the present disclosure;

FIG. 4 is an interaction flowchart of another method for wireless communication according to some embodiments of the present disclosure;

FIG. 5 is an interaction flowchart of yet another method for wireless communication according to some embodiments of the present disclosure;

FIG. 6 is an interaction flowchart of still yet another method for wireless communication according to some embodiments of the present disclosure;

FIG. 7 is a schematic diagram of a downlink data packet according to some embodiments of the present disclosure;

FIG. 8 is a schematic diagram of another downlink data packet according to some embodiments of the present disclosure;

FIG. 9 is a flowchart of a method for wireless communication according to some embodiments of the present disclosure;

FIG. 10 is an interaction flowchart of a method for wireless communication according to some embodiments of the present disclosure;

FIG. 11 is an interaction flowchart of another method for wireless communication according to some embodiments of the present disclosure;

FIG. 12 is an interaction flowchart of yet another method for wireless communication according to some embodiments of the present disclosure;

FIG. 13 is a schematic diagram of a core network device 1300 according to some embodiments of the present disclosure;

FIG. 14 is a schematic diagram of an access network device 1400 according to some embodiments of the present disclosure;

FIG. 15 is a schematic diagram of a terminal device 1500 according to some embodiments of the present disclosure;

FIG. 16 is a schematic structural diagram of a communication device 1600 according to some embodiments of the present disclosure; and

FIG. 17 is a schematic structural diagram of an apparatus according to some embodiments of the present disclosure.

### DETAILED DESCRIPTION

The technical solutions according to the embodiments of the present disclosure are described hereinafter with reference to the accompanying drawings in the embodiments of the present disclosure. It is obvious that the described embodiments are merely some rather than all of the embodiments of the present disclosure. All other embodiments derived by those of ordinary skill in the art based on the embodiments of the present disclosure without creative efforts shall fall within the protection scope of the present disclosure.

The technical solutions according to the embodiments of the present disclosure may be applicable to various communication systems, such as a global system for mobile communications (GSM), a code division multiple access (CDMA) system, a wideband code division multiple access

(WCDMA) system, a general packet radio system (GPRS) system, a long-term evolution (LTE) system, an advanced LTE (LTE-A) system, a new radio (NR) system, an evolution system of the

NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a next-generation communication system, or other communication systems.

Generally, a conventional communication system supports a limited quantity of connections and is easy to implement. However, with development of communication technologies, a mobile communication system supports device-to-device (D2D) communications, machine-to-machine (M2M) communications, machine-type communications (MTC), vehicle-to-vehicle (V2V) communications, vehicle-to-everything (V2X) communications, and the like in addition to conventional communication. The communication systems are applicable to the embodiments of the present disclosure.

In some embodiments, the communication system in the embodiments of the present disclosure may be applicable to a carrier aggregation (CA) scenario, a dual connectivity (DC) scenario, or a standalone (SA) networking scenario.

The embodiments of the present disclosure do not limit the spectrum used. For example, the embodiments of the present disclosure are applicable to a licensed spectrum as well as an unlicensed spectrum.

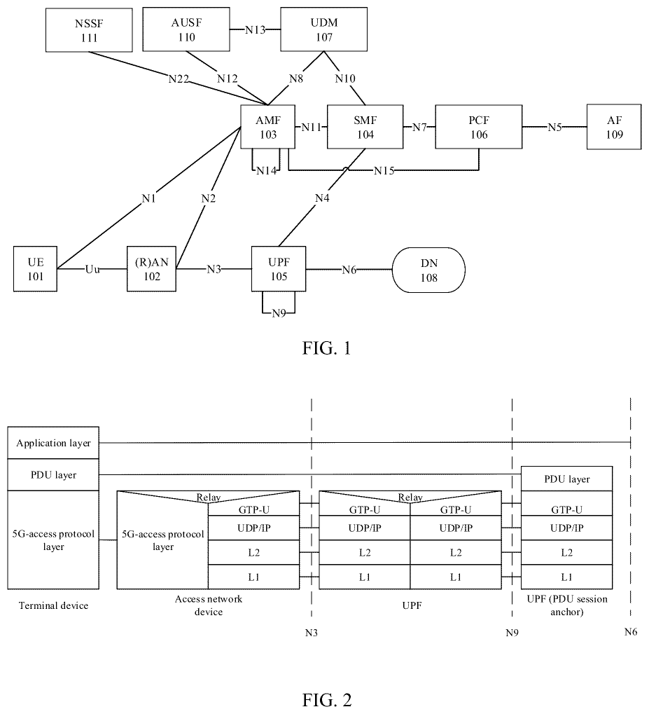

FIG. 1 exemplarily illustrates a schematic diagram of a communication system 100 to which the present disclosure is appliable. As shown in FIG. 1, the communication system 100 mainly includes a terminal device (a user equipment, UE) 101, an access network (AN) device 102, an access and mobility management function (AMF) entity 103, a session management function (SMF) entity 104, a user plane function (UPF) entity 105, a policy control function (PCF) entity 106, a unified data management (UDM) entity 107, a data network (DN) 108, an application function (AF) entity 109, an authentication server function (AUSF) entity 110, and a network slice selection function (NSSF) entity 111.

In some embodiments, in the communication system 100, the UE 101 establishes an access stratum connection to the AN device 102 over a Uu interface to implement access stratum messages interaction and wireless data transmission. The UE 101 establishes a non-access stratum (NAS) connection to the AMF entity 103 over an N1 interface to implement NAS messages interaction. The AN device 102 is connected to the AMF entity 103 over an N2 interface, and connected to the UPF entity 105 over an N3 interface. A plurality of UPF entities 105 are connected to each other over an N9 interface, and the UPF entity 105 is connected to the DN 108 over an N6 interface, and connected to the SMF entity 104 over an N4 interface. The SMF entity 104 is connected to the PCF entity 106 over the N7 interface, and connected to the UDM entity 107 over an N10 interface. The SMF entity 104 controls the UPF entity 105 over the N4 interface, and the SMF entity 104 is connected to the AMF entity 103 over an N11 interface. A plurality of AMF entities 103 are connected to each other over an N14 interface, and the AMF entity 103 is connected to the UDM entity 107 over an N8 interface, connected to the AUSF entity 110 over an N12 interface, connected to the NSSF entity 111 over an N22 interface, and connected to the PCF entity 106 over an N15 interface. The PCF entity 106 is connected to the AF entity 109 over an N5 interface. The AUSF entity 110 is connected to the UDM entity 107 over an N13 interface.

In the communication system 100, the UDM entity 107 is a subscription database within the core network, storing the subscription data of users in the 5G network. The AMF entity 103 is the mobility management function within the core network, and the SMF entity 104 is the session management function within the core network. Besides performing the mobility management on the UE 101, the AMF entity 103 is also responsible for forwarding session management-related messages between the UE 101 and the SMF entity 104. The PCF entity 106 is the policy management function within the core network, and responsible for formulating policies related to mobility management, session management, charging, and the like for the UE 101. The UPF entity 105 is the user plane function within the core network, conducting data transmission with external data networks over the N6 interface and with the AN device 102 over the N3 interface. Upon accessing the 5G network over the Uu interface, the UE 101 establishes a protocol data unit (PDU) session data connection from the UE 101 to the UPF entity 105 under the control of the SMF entity 104 to transmit data. The AMF entity 103 and the SMF entity 104 acquire user subscription data from the UDM entity 107 over the N8 and N10 interfaces, respectively, and acquire policy data from the PCF entity 106 over the N15 and N7 interfaces, respectively.

Additionally, the communication system 100 includes a network exposure function (NEF) entity, which is configured to transmit information with a third-party application server interface between a core network node and a third-party application.

It should be noted that the communication system 100 is illustrated using a 5th generation (5G) communication system as an example. However, the present disclosure may also be applicable to other 3^{rd} Generation Partnership Project (3GPP) communication systems, such as a 4^{th} generation (4G) communication system, or future 3GPP communication systems, which is not limited in the present disclosure.

It should be understood that a device with a communication function in the networks/systems in the embodiments of the present disclosure is referred to as a communication device.

It should be understood that the terms “system” and “network” herein are often used interchangeably. The term “and/or” herein merely describes an association relationship between associated objects, and indicates that three types of relationships may exist. For example, the phrase “A and/or B” means (A), (B), or (A and B). In addition, the symbol “/” herein generally indicates an “or” relationship between the associated objects.

The embodiments of the present disclosure are described in conjunction with a terminal device, an access network device, and a core network device. The terminal device may also be referred to as a user equipment (UE), an access terminal, a subscriber unit, a subscriber station, a rover station, a mobile station, a remote station, a remote terminal, a mobile device, a user terminal, a terminal, a wireless communication device, a user agent, a user device, or the like. The terminal device may be a station (ST) in a WLAN, a cellular phone, a cordless phone, a Session Initiation Protocol (SIP) phone, a wireless local loop (WLL) ST, a personal digital assistant (PDA), a handheld device with a wireless communication function, a computing device or another processing device connected to a wireless modem, a vehicle-mounted device, a wearable device, a terminal device in a next-generation communication system such as an NR network, a terminal device in a future evolved public land mobile network (PLMN), or the like.

By way of example but not limitation, in the embodiments of the present disclosure, the terminal device may alternatively be a wearable device. The wearable device may also be referred to as a wearable intelligent device, and is a generic name of wearable devices such as glasses, gloves, watches, clothing, or shoes, which are intelligently designed and developed for daily wear using wearable technologies. The wearable device is a portable device that is directly worn or integrated into a user's clothing or accessories. The wearable device is not only a hardware device, but also implements powerful functions by software support, data interaction, and cloud interaction. The wearable intelligent devices in a broad sense include devices such as smart watches or smart glasses that have full functionality and large size, and are capable of implementing all or part of functionality without depending on the smart phone, and devices such as various kinds of smart bracelets and smart jewelries for monitoring physical signs, which are dedicated to a specific type of application functions and need to be used in conjunction with other devices like the smart phone.

In some embodiments of the present disclosure, the access network device may be a device for communicating with a mobile device. The access network device may be an access point (AP) in a WLAN, a base transceiver station (BTS) in a GSM or CDMA system, a NodeB (NB) in a WCDMA system, an evolved NodeB (eNB or eNodeB) in an LTE system, a relay station, an AP, a vehicle-mounted device, a wearable device, a gNodeB (gNB) in an NR network, a network device in a future evolved PLMN, or the like.

In the embodiments of the present disclosure, the access network device may provide services for a cell. A terminal device communicates with the access network device over transmission resources (for example, frequency domain resources or spectrum resources) used by the cell. The cell may be a cell corresponding to the access network device (for example, a base station). The cell may belong to a macro base station or a base station corresponding to a small cell. The small cell may include a metro cell, a micro cell, a pico cell, a femto cell, or the like. The small cell features small coverage and low transmit power, and is suitable for providing high-rate data transmission services.

FIG. 2 exemplarily illustrates a schematic diagram of a user plane protocol stack. As shown in FIG. 2, the UPF is capable of parsing up to the PDU layer of a data packet at most; for example, the UPF is capable of parsing the Internet Protocol (IP) layer of the data packet but fails to parse up to the application layer. In addition, the access network device is capable of parsing up to the user-plane part of Tunneling Protocol (GTP) (GTP-U) layer at most but also fails to parse up to the application layer. Typically, the application layer packet header information of a data packet may carry information about a data set that has a dependency relationship with the data packet. For example, a current video frame may include at least one data packet, and the application layer packet header information of these data packets may carry information about the reference frame of the current video frame, such as the identifier of the reference frame. However, since neither the UPF nor the access network device is capable of parsing up to the application layer, the access network device fails to acquire the information of the reference frame of the current video frame. Consequently, the access network device fails to determine the transmission status of the reference frame and directly transmits the current video frame to the terminal device. The terminal device, upon receiving the current video frame, determines whether the reference frame of the current video frame has been transmitted or decoded successfully. In the case that the transmission or decoding of the reference frame fails, the terminal device discards the current video frame, which leads to a waste of air interface resources. For uplink data, although the terminal device is capable of parsing the application layer packet header information, it still directly transmits the current video frame to the access network device. The access network device, upon receiving the current video frame, determines whether the reference frame of the current video frame has been transmitted or decoded successfully. In the case that the transmission or decoding of the reference frame fails, the access network device discards the current video frame, which also leads to a waste of air interface resources.

To address the above technical problem, in the present disclosure, for downlink data, the access network device is capable of acquiring the information of the reference frame, and hence is capable of determining the transmission status of the reference frame and consequently is capable of determining whether to transmit the current video frame. For uplink data, the terminal device is capable of acquiring the information of the reference frame, and hence is capable of determining the transmission status of the reference frame and consequently is capable of determining whether to transmit the current video frame.

It should be understood that in the present disclosure, downlink data refers to data transmitted from the peer terminal or application server to the local terminal. Uplink data refers to data transmitted from the local terminal to the peer terminal or application server.

It should be understood that besides a dependency relationship between video frames, other data, such as coded slices (or video slices), also have a dependency relationship, and even other forms of data have a dependency relationship. Based on this, in the present disclosure, a video frame or a coded slice is referred to as a data set, which may also be called a data unit. Each data set includes one or more data packets, wherein the data packets in any one of the data sets have the same importance at the application layer.

Currently, for downlink data, upon acquiring a current video frame, an access network device fails to determine a transmission status of a reference frame of the current video frame, and directly transmits the current video frame to the terminal device. Upon receiving the current video frame, the terminal device determines whether the reference frame of the current video frame has been transmitted or decoded successfully. In the case that the transmission or decoding of the reference frame fails, the terminal device discards the current video frame, which leads to a waste of air interface resources. For uplink data, upon acquiring the current video frame, the terminal device also directly transmits the current video frame to the access network device. Upon receiving the current video frame, the access network device determines whether the reference frame of the current video frame has been transmitted or decoded successfully. In the case that the transmission or decoding of the reference frame fails, the access network device discards the current video frame, which also leads to a waste of air interface resources.

The technical solutions of the present disclosure are described in detail hereinafter.

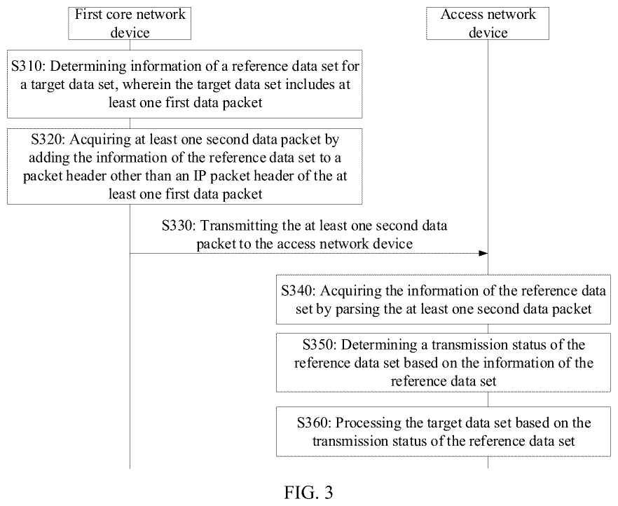

FIG. 3 is an interaction flowchart of a method for wireless communication according to some embodiments of the present disclosure. As shown in FIG. 3, the method includes the following processes.

In S310, a first core network device determines information of a reference data set for a target data set, wherein the target data set includes at least one first data packet.

In S320, the first core network device acquires at least one second data packet by adding the information of the reference data set to a packet header other than an IP packet header of the at least one first data packet.

In S330, the first core network device transmits the at least one second data packet to an access network device.

In S340, the access network device acquires the information of the reference data set by parsing the at least one second data packet.

In S350, the access network device determines the transmission status of the reference data set based on the information of the reference data set.

In S360, the access network device processes the target data set based on the transmission status of the reference data set.

In some embodiments, the first core network device is a core network user plane network element, such as a UPF.

In some embodiments, the target data set includes video frames, coded slices, or the like, which is not limited in the present disclosure.

In some embodiments, the reference data set of the target data set is a data set that has a dependency relationship with the target data set.

Exemplarily, in the case that the target data set is a video frame, the reference data set is the reference frame of the video frame.

In some embodiments, the dependency relationship between the reference data set and the target data set is also referred to as the attachment relationship between the reference data set and the target data set, or the like, which is not limited in the present disclosure.

In some embodiments, the target data set has one or more reference data sets.

Exemplarily, in the case that the target data set is a P-frame, the reference data set thereof is a previous I-frame or a previous P-frame of the P-frame. For another example, in the case that the target data set is a B-frame, the reference data set thereof is a previous frame and the next frame of the B-frame.

It should be understood that the at least one first data packet originates from an application server or a peer terminal. In other words, the at least one first data packet is a data packet on the N6 interface.

It should be understood that the at least one first data packet is a data packet in the target data set to which the information of the reference data set is to be added.

In some embodiments, the at least one first data packet is part of or all of the data packets of the target data set.

Exemplarily, in the case that a certain video frame includes 10 data packets, each data packet among the data packets is added with the information of the reference frame in the packet header other than the IP packet header. Alternatively, part of the data packets among the data packets, such as those with odd numbers, are added with the information of the reference frame in the packet header other than the IP packet header.

In some embodiments, the part of the data packets are specific data packets or data packets randomly selected from the target data set.

Exemplarily, in the case that a certain video frame includes 10 data packets, and the specific data packets are the first and the last data packets among the 10 data packets, then both the first and the last data packets are added with the information of the reference frame in the packet header other than the IP packet header.

Exemplarily, in the case that a certain video frame includes 10 data packets, the first core network device randomly selects one or more data packets from the 10 data packets. For example, the first data packet is selected, then the first data packet is added with the information of the reference frame in the packet header other than the IP packet header.

In some embodiments, the above specific data packets are predefined or device-configured. For example, the specific data packets are indicated by the second core network device or other devices.

In some embodiments, the second core network device is a core network control plane network element, such as an SMF.

In some embodiments, the first core network device determines the information of the reference data set for the target data set in the following implementations, but is not limited to these:
Implementation 1: The first core network device determines the information of the reference data set based on the application layer packet header information of at least one first data packet.
Implementation 2: The first core network device receives the information of the data set sequence from the second core network device, wherein the data set sequence includes the reference data set and the target data set; and determines the information of the reference data set based on the information of the data set sequence.
Implementation 1 is described hereinafter.

In some embodiments, the first core network device is capable of parsing the application layer packet header information of the data packets in the target data set. Based on the application layer packet header information, the first core network device determines the information of the reference data set.

In the present disclosure, the application layer refers to protocol layers above the PDU layer, including but not limited to at least one of: a Real-time Transport Protocol (RTP) layer, a Hypertext Transfer Protocol (HTTP) layer, data compression layers such as H.264, H.265, or a Moving Picture Experts Group (MPEG) coding layer. The corresponding application layer packet headers include, for example, at least one of: an RTP packet header, an HTTP packet header, an H.264 packet header, an H.265 packet header, or an MPEG packet header. Exemplarily, the first core network device is capable of reading the RTP packet header or a data packet header encoded and compressed using video codec technology such as H.264, H.265, or MPEG.

In some embodiments, the data packets parsed by the first core network device are any one or more data packets in the target data set.

Exemplarily, the data packets parsed by the first core network device are the above at least one first data packet. In other words, the data packets parsed by the first core network device are the same as the data packets to which the information of the reference data set is to be added. Alternatively, the data packets parsed by the first core network device are not any of the above first data packets. That is, the data packets parsed by the first core network device are different from the data packets to which the information of the reference data set is to be added. Alternatively, the data packets parsed by the first core network device are partially the same as the above at least one first data packet, with the rest being different.

In some embodiments, the application layer packet header information includes the information of the reference data set.

Exemplarily, in the case that the target data set is a video frame that includes 10 data packets, the application layer packet header information of each data packet includes the identifier of the reference frame.

In some embodiments, the application layer packet header information does not directly include the information of the reference data set but allows determining the information of the reference data set based on the application layer packet header information.

Exemplarily, in the case that the target data set is a video frame that includes 10 data packets, the application layer packet header information of each data packet includes the frame type of the video frame, such as P-frame type. Based on this, the first core network device is capable of determining that a previous I-frame or P-frame of the video frame is the reference frame thereof and thus is capable of determining the identifier of the previous I-frame or P-frame.

In some embodiments, the information of the reference data set includes at least one of but is not limited to: the identifier of the reference data set or the association information between the reference data set and the target data set.

In some embodiments, the association information between the reference data set and the target data set is the spacing information between the reference data set and the target data set.

In some embodiments, the spacing information between the reference data set and the target data set is the time interval between the reference data set and the target data set, but is not limited thereto.

In some embodiments, the spacing information “−N” indicates counting from the data set immediately before the target data set, wherein the N^{th} preceding data set is the reference data set of the target data set. The spacing information “+N” indicates counting from the data set immediately after the target data set, wherein the N^{th} next data set is the reference data set of the target data set.

Exemplarily, in the case that the information of the reference data set includes “−1”, then the first core network device determines that the data set immediately before the target data set is the reference data set of the target data set. In the case that the information of the reference data set includes “+1”, then the first core network device determines that the data set immediately after the target data set is the reference data set of the target data set.

In some embodiments, “+N” indicates counting from the data set immediately before the target data set, wherein the N^{th} preceding data set is the reference data set of the target data set. “−N” indicates counting from the data set immediately after the target data set, wherein the N^{th} next data set is the reference data set of the target data set. N is a positive integer.

Exemplarily, in the case that the information of the reference data set includes “+1”, then the first core network device determines that the data set immediately before the target data set is the reference data set of the target data set. In the case that the information of the reference data set includes “−1”, then the first core network device determines that the data set immediately after the target data set is the reference data set of the target data set.

In some embodiments, the first core network device receives a first indication from the second core network device. Accordingly, determining the information of the reference data set for the target data set, and/or acquiring the at least one second data packet adding the information of the reference data set in the packet header other than the IP packet header of at the least one first data packet, includes: determining the information of the reference data set based on the first indication, and/or acquiring the at least one second data packet by adding the information of the reference data set to the packet header other than the IP packet header of the at least one first data packet based on the first indication. That is, the first indication is used to instruct to determine the information of the reference data set, and/or to acquire the at least one second data packet by adding the information of the reference data set to the packet header other than the IP packet header of the at least one first data packet based on the first indication.

In some embodiments, the first indication is transmitted by a third core network device to the second core network device.

In some embodiments, the third core network device is a core network control plane network element, such as a PCF.

In some embodiments, the first indication is transmitted by a fourth core network device to the third core network device.

In some embodiments, the fourth core network device is a core network control plane network element, such as an AF.

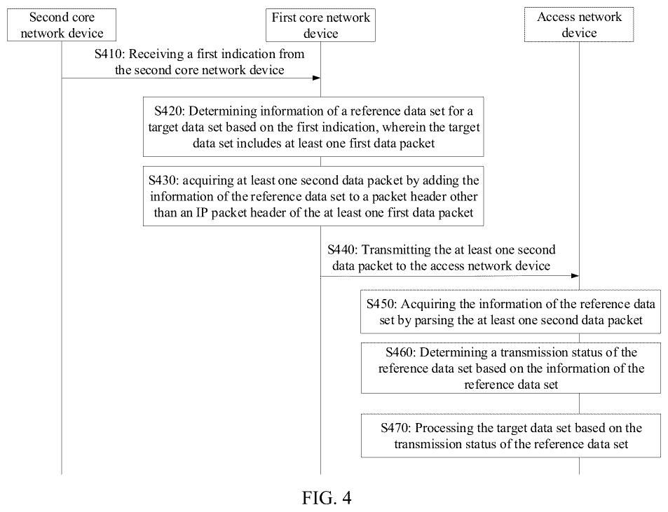

Exemplarily, FIG. 4 is an interaction flowchart of another method for wireless communication according to some embodiments of the present disclosure. As shown in FIG. 4, the method includes the following processes.

In S410, a first core network device receives a first indication from a second core network device.

In S420, the first core network device determines information of a reference data set for a target data set based on the first indication, wherein the target data set includes at least one first data packet.

In S430, the first core network device acquires at least one second data packet by adding the information of the reference data set to a packet header other than an IP packet header of the at least one first data packet.

In S440, the first core network device transmits the at least one second data packet to an access network device.

In S450, the access network device acquires the information of the reference data set by parsing the at least one second data packet.

In S460, the access network device determines the transmission status of the reference data set based on the information of the reference data set.

In S470, the access network device processes the target data set based on the transmission status of the reference data set.

In other words, the first indication is used to instruct to determine the information of the reference data set for the target data set.

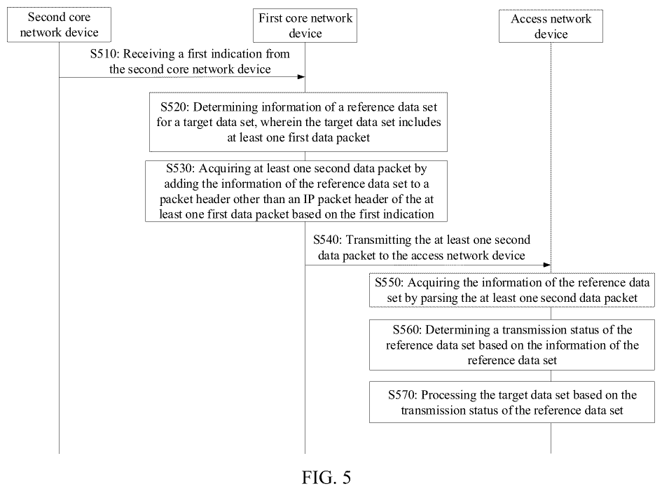

Exemplarily, FIG. 5 is an interaction flowchart of yet another method for wireless communication according to some embodiments of the present disclosure. As shown in FIG. 5, the method includes the following processes.

In S510, a first core network device receives a first indication from a second core network device.

In S520, the first core network device determines information of a reference data set for a target data set, wherein the target data set includes at least one first data packet.

In S530, the first core network device acquires at least one second data packet by adding the information of the reference data set to a packet header other than the IP packet header of the at least one first data packet based on the first indication.

In S540, the first core network device transmits the at least one second data packet to an access network device.

In S550, the access network device acquires the information of the reference data set by parsing the at least one second data packet.

In S560, the access network device determines the transmission status of the reference data set based on the information of the reference data set.

In S570, the access network device processes the target data set based on the transmission status of the reference data set.

That is, the first indication is used to instruct to acquire at least one second data packet by adding the information of the reference data set into the packet header other than the IP packet header of the at least one first data packet.

It should be understood that process S510 only needs to be executed prior to process S530. For example, process S510 is executed between process S520 and process S530, or process S510 is executed prior to process S520. In any case, the execution order of process S510 and process

S520 is not limited in present disclosure.

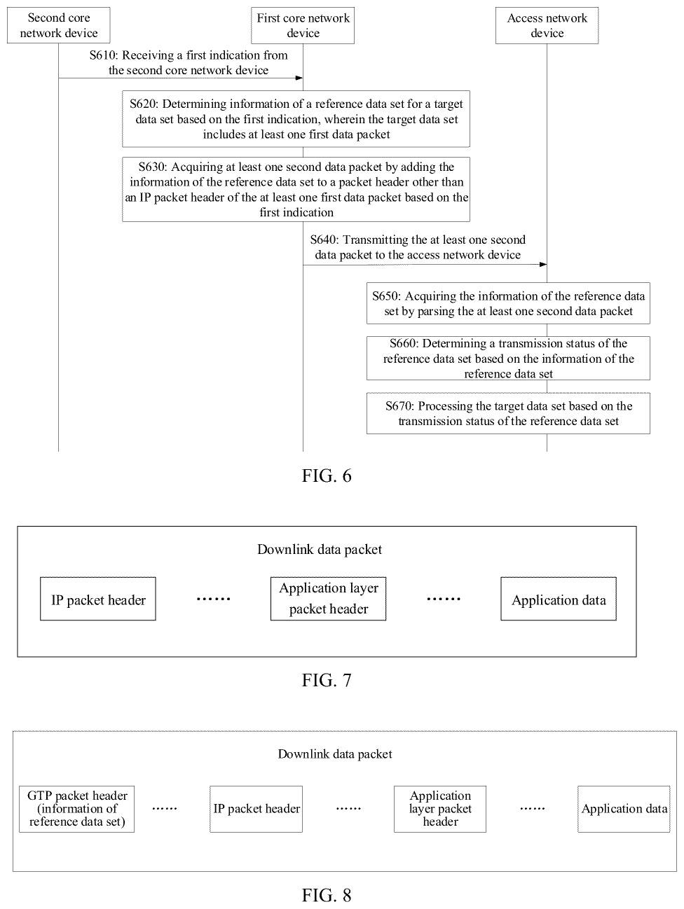

Exemplarily, FIG. 6 is an interaction flowchart of still yet another method for wireless communication according to some embodiments of the present disclosure. As shown in FIG. 6, the method includes the following processes.

In S610, a first core network device receives a first indication from a second core network device.

In S620, the first core network device determines information of a reference data set for a target data set based on the first indication, wherein the target data set includes at least one first data packet.

In S630, the first core network device acquires at least one second data packet by adding the information of the reference data set to a packet header other than the IP packet header of the at least one first data packet based on the first indication.

In S640, the first core network device transmits the at least one second data packet to an access network device.

In S650, the access network device acquires the information of the reference data set by parsing the at least one second data packet.

In S660, the access network device determines the transmission status of the reference data set based on the information of the reference data set.

In S670, the access network device processes the target data set based on the transmission status of the reference data set.

That is, the first indication is used to instruct to determine the information of the reference data set for the target data set, and to acquire at least one second data packet by adding the information of the reference data set into the packet header other than the IP packet header of the at least one first data packet.

In some embodiments, the first core network device parses the application layer packet header information of the data packets in the target data set and determines the identifier of the target data set based on the application layer packet header information.

In some embodiments, the application layer packet header information includes the identifier of the target data set.

Exemplarily, in the case that the target data set is a video frame that includes 10 data packets, the application layer packet header information of each data packet includes the identifier of the video frame.

Implementation 2 is described hereinafter.

It should be understood that in Implementation 2, the first core network device does not need to parse the application layer packet header information of the data packet. Based on this, Implementation 2 may be applicable to a scenario where data is encrypted, such as the target data set is encrypted and the first core network device fails to read the application layer packet header information. Implementation 2 may also be applicable to scenarios where the first core network device is capable of reading the application layer packet header information but fails to directly acquire the information of the reference data set from the application layer packet header information. In any case, the application scenarios of Implementation 2 is not limited in the present disclosure.

In some embodiments, the information of the data set sequence includes a sequence composed of the types or importance levels of data sets in the data set sequence.

Exemplarily, in the case that each data set in the data set sequence is a video frame, then the type of the video frame is an I-frame type, a P-frame type, or a B-frame type.

In some embodiments, the importance level of each data set in the data set sequence is predefined, indicated by the second core network device, or indicated by other devices, which is not limited in the present disclosure.

In some embodiments, the importance level of a data set has a corresponding relationship with the type of the data set.

Exemplarily, in the case that each data set in the data set sequence is a video frame, then the type of the video frame is an I-frame type, a P-frame type, or a B-frame type; the importance level of an I-frame is higher than that of a P-frame, and the importance level of a P-frame is higher than that of a B-frame.

It should be understood that the sequence composed of the types or importance levels of data sets in the data set sequence may be used to determine the information of the reference data set.

Exemplarily, in the case that each data set in the data set sequence is a video frame, the information of the data set sequence includes a video frame type sequence of I-frame, P-frame, and P-frame. Based on this, the first core network device determines that the second video frame and the reference frame thereof, i.e., the first video frame, have spacing information of “+1”, and that the third video frame and the reference frame thereof, i.e., the second video frame, also have spacing information of “+1”.

Exemplarily, in the case that each data set in the data set sequence is a video frame, the information of the data set sequence includes a video frame type sequence of I-frame, P-frame, and P-frame. Based on this, the first core network device determines that the reference frame of the second video frame is the first video frame and further determine the identifier of the first video frame, and that the reference frame of the third video frame is the second video frame and further determine the identifier of the second video frame.

Exemplarily, in the case that each data set in the data set sequence is a video frame, the information of the data set sequence includes a video frame importance level sequence of level 1, level 2, and level 3. In the case that the video frame of level 2 references the video frame of level 1, and the video frame of level 3 references the video frame of level 2, then based on this, the first core network device determines that the second video frame and the reference frame thereof, i.e., the first video frame, have spacing information of “+1”, and that the third video frame and the reference frame thereof, i.e., the second video frame, also have spacing information of “+1”.

Exemplarily, in the case that each data set in the data set sequence is a video frame, the information of the data set sequence includes a video frame importance level sequence of level 1, level 2, and level 3. In the case that the video frame of level 2 references the video frame of level 1, and the video frame of level 3 references the video frame of level 2, then based on this, the first core network device determines that the reference frame of the second video frame is the first video frame and further determine the identifier of the first video frame, and that the reference frame of the third video frame is the second video frame and further determine the identifier of the second video frame.

In some embodiments, the information of the data set sequence further includes the time intervals of the data sets.

It should be understood that in the case that each data set in the data set sequence is a video frame, then the time intervals of the data sets are related to the frame rate at which the video frames are captured. For example, the frame rate is 30 frames per second, it means that a video frame is captured every 33 ms, and the type or importance level of the video frame within every 33 ms may be determined combining the type sequence or importance level sequence of the video frame. That is, the time intervals of the data sets may be used to distinguish the data sest, and combining it with the type sequence or importance level sequence of the video frame, the type or importance level of each video frame may be further determined. Based on this, the identifier of the reference frame or the spacing information relative to the reference frame may be better added to the data packets in each video frame.

Exemplarily, in the case that each data set in the data set sequence is a video frame, and the frame rate is 30 frames per second, it means that there is a video frame every 33 ms; in the case that the video frame type sequence is: I-frame, P-frame, P-frame, B-frame, P-frame, then the video frame received within the first 33 ms should be an I-frame, the video frame received within the second 33 ms should be a P-frame, the video frame received within the third 33 ms should be a P-frame, the video frame received within the fourth 33 ms should be a B-frame, and the video frame received within the fifth 33 ms should be a P-frame.

In some embodiments, the application layer packet header information includes the identifier of the target data set.

Exemplarily, in the case that the target data set is a video frame that includes 10 data packets, the application layer packet header information of each data packet includes the identifier of the video frame.

It should be understood that for the explanation regarding the information of the reference data set, reference may be made to the content in Implementation 1, which is not described any further in the present disclosure.

Processes S320 to S360 are described hereinafter.

FIG. 7 is a schematic diagram of a downlink data packet according to some embodiments of the present disclosure. As shown in FIG. 7, the downlink data packet includes application data, an application layer packet header, and an IP packet header. In a video transmission scenario, the application data may be the pixels in a video frame and the attributes of the pixels. The application layer packet header information may be used to determine the information of the reference data set, or the first core network device may determine the information of the reference data set through the above Implementation 2. The IP packet header may include the IP of the application server and the IP of the terminal device. The application server may be a cloud gaming server in a cloud gaming scenario, and the terminal device is the receiver end of the downlink data packet, i.e., the peer terminal. As can be known from FIG. 2, currently the access network device is capable of parsing up to the GTP-U layer at most, and it fails to parse the above downlink data packet. Based on this, in some embodiments, the first core network device, upon determining the information of the reference data set for the target data set, adds the information to the packet header other than the IP packet header of the first data packet. For example, the information is added to the GPRS Tunneling Protocol (GTP) packet header of the first data packet, as long as a location that the access network device is capable of parsing up to.

Exemplarily, FIG. 8 is a schematic diagram of another downlink data packet according to some embodiments of the present disclosure. As shown in FIG. 8, the first core network device adds the information of the reference data set to the GTP packet header of the first data packet.

It should be understood that the ellipsis in FIGS. 7 and 8 indicate that some other information may be present or no information at all.

In some embodiments, the first core network device further determines the identifier of the target data set and adds the identifier of the target data set to the packet header other than the IP packet header of at least one first data packet. For example, the identifier of the target data set may be added to the GTP packet header of the first data packet, as long as a location that the access network device is capable of parsing up to.

In some embodiments, the access network device receives a second indication from the second core network device. Accordingly, parsing at least one second data packet, and/or processing the target data set based on the transmission status of the reference data set, includes: parsing at least one second data packet based on the second indication, and/or processing the target data set based on the second indication and the transmission status of the reference data set. That is, the second indication is used to instruct to parse at least one second data packet and/or process of the target data set based on the second indication and the transmission status of the reference data set.

In some embodiments, the second indication is transmitted by a third core network device to the second core network device.

In some embodiments, the third core network device is a core network control plane network element, such as a PCF.

In some embodiments, the second indication is transmitted by a fourth core network device to the third core network device.

In some embodiments, the fourth core network device is a core network control plane network element, such as an AF.

It should be understood that the transmission status of the reference data set may include both transmission failure and transmission success.

In some embodiments, in response to determining, based on the transmission status of the reference data set, that the reference data set fails to be transmitted correctly, the access network device discards the reference data set and/or the target data set.

Exemplarily, in the case that a certain target video frame is a P-frame, and its preceding I-frame is its reference frame, the access network device discards the target video frame in the case that the transmission of the reference frame fails.

In some embodiments, in the case that the target data set has a plurality of reference data sets, as long as the transmission of at least one reference data set fails, the access network device discards the reference data set whose transmission fails and/or the target data set.

Exemplarily, in the case that a certain target video frame is a P-frame, and its preceding two frames are its reference frames, the access network device discards the target video frame in the case that the transmission of one of the reference frames fails.

In summary, in the technical solutions of the present disclosure, the first core network device is capable of determining the information of the reference data set for the target data set, acquiring at least one second data packet by adding the information to the packet header other than the IP packet header of at least one first data packet, and transmitting the at least one second data packet to the access network device. In this way, the access network device is capable of acquiring the information of the reference data set, and hence is capable of determining the transmission status of the reference data set and consequently is capable of processing the target data set based on the transmission status of the reference data set. For example, in the case that the transmission of the reference data set fails, the target data set may be discarded, such that air interface resources are saved.

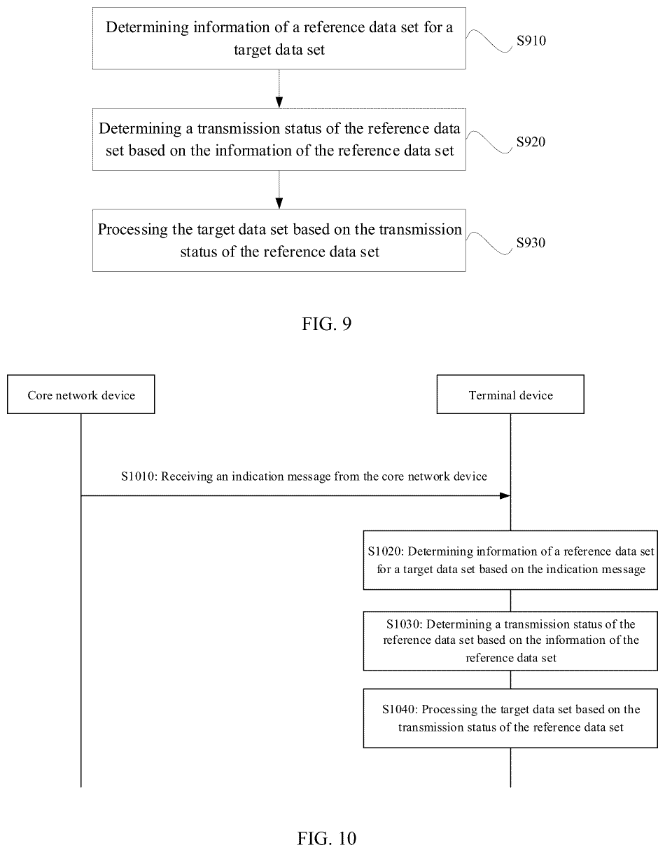

FIG. 9 is a flowchart of a method for wireless communication according to some embodiments of the present disclosure. The method is applicable to a terminal device. As shown in FIG. 9, the method includes the following processes.

In S910, information of a reference data set for a target data set is determined.

In S920, a transmission status of the reference data set is determined based on the information of the reference data set.

In S930, the target data set is processed based on the transmission status of the reference data set.

In some embodiments, the target data set includes video frames, coded slices, or the like, which is not limited in the present disclosure.

In some embodiments, the reference data set of the target data set is a data set that has a dependency relationship with the target data set.

Exemplarily, in the case that the target data set is a video frame, the reference data set is the reference frame of the video frame.

In some embodiments, the dependency relationship between the reference data set and the target data set is also referred to as the attachment relationship between the reference data set and the target data set, or the like, which is not limited in the present disclosure.

In some embodiments, the target data set has one or more reference data sets.

Exemplarily, in the case that the target data set is a P-frame, the reference data set thereof is the preceding I-frame or the preceding P-frame of the P-frame. For another example, in the case that the target data set is a B-frame, the reference data set thereof is the preceding frame and the next frame of the B-frame.

In some embodiments, the target data set includes at least one first data packet, and the information of the reference data set is determined by the terminal device based on the application layer packet header information of the at least one first data packet. That is, the first data packet here is a data packet whose application layer packet header information is parsed by the terminal device.

In some embodiments, the above at least one first data packet is part of or all of the data packets of the target data set.

In some embodiments, the above part of the data packets are specific data packets or data packets randomly selected from the target data set.

It should be understood that, as illustrated in FIG. 2, the terminal device is capable of parsing up to the application layer.

In some embodiments, the application layer packet header information includes the information of the reference data set.

Exemplarily, in the case that the target data set is a video frame that includes 10 data packets, the application layer packet header information of each data packet includes the identifier of the reference frame.

In some embodiments, the application layer packet header information does not directly include the information of the reference data set but allows determining the information of the reference data set based on the application layer packet header information.

Exemplarily, in the case that the target data set is a video frame that includes 10 data packets, the application layer packet header information of each data packet includes the frame type of the video frame, such as P-frame type. Based on this, the terminal device determines that the preceding I-frame or P-frame of the video frame is the reference frame thereof and thus determine the identifier of the preceding I-frame or P-frame.

In some embodiments, the information of the reference data set includes at least one of but is not limited to: the identifier of the reference data set or the association information between the reference data set and the target data set.

In some embodiments, the association information between the reference data set and the target data set is the spacing information between the reference data set and the target data set.

In some embodiments, the spacing information between the reference data set and the target data set is the time interval between the reference data set and the target data set, but is not limited thereto.

In some embodiments, the spacing information “−N” indicates counting from the data set immediately before the target data set, wherein the N^{th} preceding data set is the reference data set of the target data set. The spacing information “+N” indicates counting from the data set immediately after the target data set, wherein the N^{th} next data set is the reference data set of the target data set.

Exemplarily, in the case that the information of the reference data set includes “−1”, then the terminal device determines that the data set immediately before the target data set is the reference data set of the target data set; in the case that the information of the reference data set includes “+1”, then the terminal device determines that the data set immediately after the target data set is the reference data set of the target data set.

In some embodiments, “+N” indicates counting from the data set immediately before the target data set, wherein the N^{th} preceding data set is the reference data set of the target data set. “−N” indicates counting from the data set immediately after the target data set, wherein the N^{th} next data set is the reference data set of the target data set. N is a positive integer.

Exemplarily, in the case that the information of the reference data set includes “+1”, then the terminal device determines that the data set immediately before the target data set is the reference data set of the target data set; in the case that the information of the reference data set includes “−1”, then the terminal device determines that the data set immediately after the target data set is the reference data set of the target data set.

In some embodiments, the terminal device receives an indication message from the core network device. Accordingly, determining the information of the reference data set for the target data set, and/or processing the target data set based on the transmission status of the reference data set, includes: determining the information of the reference data set for the target data set based on the indication message, and/or processing the target data set based on the indication message and the transmission status of the reference data set. That is, the indication message is used to instruct to determine the information of the reference data set for the target data set and/or process the target data set based on the transmission status of the reference data set.

In some embodiments, the core network device is referred to as the second core network device, and the second core network device is a core network control plane network element, such as an SMF.

In some embodiments, the indication message is transmitted by a third core network device to the second core network device.

In some embodiments, the third core network device is a core network control plane network element, such as a PCF.

In some embodiments, the indication message is transmitted by a fourth core network device to the third core network device.

In some embodiments, the fourth core network device is a core network control plane network element, such as an AF.

Exemplarily, FIG. 10 is an interaction flowchart of a method for wireless communication according to some embodiments of the present disclosure. As shown in FIG. 10, the method includes the following processes.

In S1010, a terminal device receives an indication message from a core network device. In S1020, the terminal device determines information of a reference data set for a target

data set based on the indication message.

In S1030, the terminal device determines a transmission status of the reference data set based on the information of the reference data set.

In S1040, the terminal device processes the target data set based on the transmission status of the reference data set.

That is, the indication message is used to instruct to determine the information of the reference data set for the target data set.

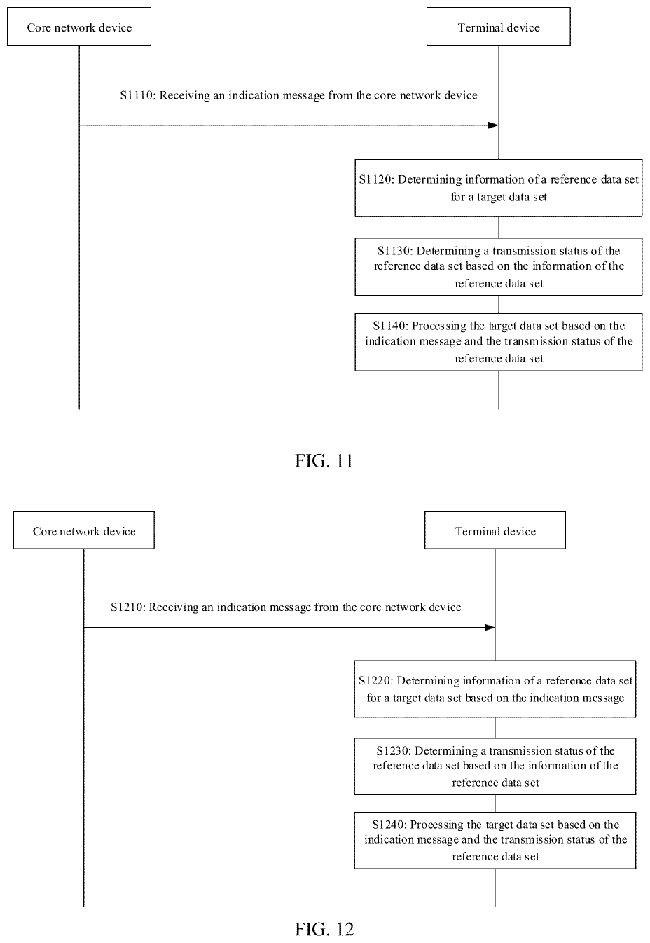

Exemplarily, FIG. 11 is an interaction flowchart of another method for wireless communication according to some embodiments of the present disclosure. As shown in FIG. 11, the method includes the following processes.

In S1110, a terminal device receives an indication message from a core network device.

In S1120, the terminal device determines information of a reference data set for a target data set.

In S1130, the terminal device determines a transmission status of the reference data set based on the information of the reference data set.

In S1140, the terminal device processes the target data set based on the indication message and the transmission status of the reference data set.

That is, the indication message is used to instruct to determine processing the target data set based on the transmission status of the reference data set.

It should be understood that process S1110 only needs to be executed prior to S1140, and the execution order between processes S1110, S1120, and S1130 is not limited in present disclosure.

Exemplarily, FIG. 12 is an interaction flowchart of yet another method for wireless communication according to some embodiments of the present disclosure. As shown in FIG. 12, the method includes the following processes.

In S1210, a terminal device receives an indication message from a core network device.

In S1220, the terminal device determines information of a reference data set for a target data set based on the indication message.

In S1230, the terminal device determines a transmission status of the reference data set based on the information of the reference data set.

In S1240, the terminal device processes the target data set based on the indication message and the transmission status of the reference data set.

That is, the indication message is used to instruct to determine the information of the reference data set for the target data set and process the target data set based on the transmission status of the reference data set.

In some embodiments, the terminal device is capable of parsing the application layer packet header information of the data packets in the target data set and determining the identifier of the target data set based on the application layer packet header information.

In some embodiments, the application layer packet header information includes the identifier of the target data set.

It should be understood that the transmission status of the reference data set may include both transmission failure and transmission success.

In some embodiments, in response to determining that the reference data set fails to be transmitted correctly based on the transmission status of the reference data set, the terminal device discards the reference data set and/or the target data set.

Exemplarily, in the case that a certain target video frame is a P-frame, and its preceding I-frame is its reference frame, the terminal device discards the target video frame in the case that the transmission of the reference frame fails.

In some embodiments, in the case that the target data set has a plurality of reference data sets, as long as the transmission of at least one reference data set fails, the terminal device discards the reference data set whose transmission fails and/or the target data set.

Exemplarily, in the case that a certain target video frame is a P-frame, and its preceding two frames are its reference frames, the terminal device discards the target video frame in the case that the transmission of one of the reference frames fails.

In summary, in the technical solutions of the present disclosure, the terminal device is capable of determining the information of the reference data set for the target data set, determining the transmission status of the reference data set based on the information of the reference data set, and processing the target data set based on the transmission status of the reference data set. For example, in the case that the transmission of the reference data set fails, the target data set may be discarded, such that air interface resources are saved.

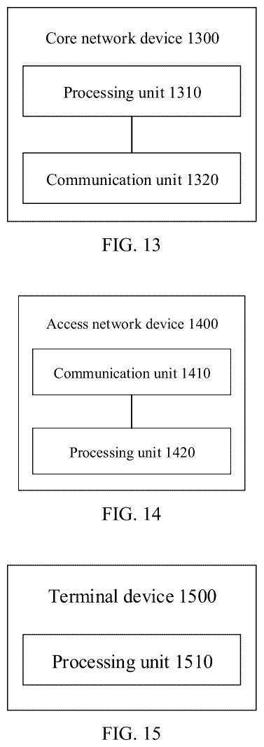

FIG. 13 is a schematic diagram of a core network device 1300 according to some embodiments of the present disclosure. The core network device 1300 is the first core network device and includes a processing unit 1310 and a communication unit 1320. The processing unit 1310 is configured to: determine information of a reference data set for a target data set, wherein the target data set includes at least one first data packet; and acquire at least one second data packet by adding the information of the reference data set to the packet header other than the Internet protocol IP packet header of the at least one first data packet. The communication unit 1320 is configured to transmit at least one second data packet to the access network device.

In some embodiments, the processing unit 1310 is specifically configured to: determine the information of the reference data set based on the application layer packet header information of the at least one first data packet.

In some embodiments, the application layer packet header information of the at least one first data packet includes the information of the reference data set.

In some embodiments, the communication unit 1320 is further configured to: receive a first indication from a second core network device; correspondingly, the processing unit 1310 is specifically configured to: determine the information of the reference data set based on the first indication, and/or to acquire at least one second data packet by adding the information of the reference data set to the packet header other than the IP packet header of the at least one first data packet based on the first indication.

In some embodiments, the communication unit 1320 is further configured to: receive the information of the data set sequence from the second core network device, wherein the data set sequence includes the reference data set and the target data set; correspondingly, the processing unit 1310 is specifically configured to: determine the information of the reference data set based on the information of the data set sequence.

In some embodiments, the information of the data set sequence includes a sequence composed of the types or importance levels of data sets in the data set sequence.

In some embodiments, the information of the data set sequence further includes the time intervals of the data sets.

In some embodiments, the at least one first data packet originates from an application server or a peer terminal.

In some embodiments, the at least one first data packet is part of or all of the data packets of the target data set.

In some embodiments, the part of the data packets are specific data packets or data packets randomly selected from the target data set.

In some embodiments, the specific data packets are predefined or device-configured.

In some embodiments, the information of the reference data set includes at least one of: the identifier of the reference data set or the association information between the reference data set and the target data set.

In some embodiments, the association information is the spacing information between the reference data set and the target data set.

In some embodiments, one or more reference data sets are defined.

In some embodiments, the processing unit 1310 is further configured to: determine the identifier of the target data set; correspondingly, the processing unit 1310 is specifically configured to: acquire at least one second data packet by adding the information of the reference data set and the identifier of the target data set to the packet header other than the IP packet header of the at least one first data packet.

In some embodiments, the target data set includes video frames or coded slices.

In some embodiments, the processing unit 1310 is specifically configured to: acquire at least one second data packet by adding the information of the reference data set to the GTP packet header of the at least one first data packet.

In some embodiments, the above communication unit is a communication interface or a transceiver, or an input-output interface of a communication chip or system on chip. The above processing unit includes one or more processors.

It should be understood that the core network device according to the embodiments of the present disclosure may correspond to the first core network device in the method embodiments, and the above and other operations and/or functions of the various units in the core network device are respectively for implementing the corresponding processes of the first core network device in the method embodiments. For brevity, details are not described herein any further.

FIG. 14 is a schematic diagram of an access network device 1400 according to some embodiments of the present disclosure. The access network device 1400 includes a communication unit 1410 and a processing unit 1420. The communication unit 1410 is configured to receive at least one second data packet from the first core network device, wherein the at least one second data packet is acquired by adding the information of a reference data set for a target data set to the packet header other than the IP packet header of at least one first data packet, wherein the target data set includes the at least one first data packet. The processing unit 1420 is configured to: acquire the information of the reference data set by parsing the at least one second data packet; determine the transmission status of the reference data set based on the information of the reference data set; and process the target data set based on the transmission status of the reference data set.

In some embodiments, the information of the reference data set is determined by the first core network device based on the application layer packet header information of the at least one first data packet.

In some embodiments, the application layer packet header information of the at least one first data packet includes the information of the reference data set.

In some embodiments, the communication unit 1410 is further configured to: receive a second indication from the second core network device; correspondingly, the processing unit 1420 is specifically configured to: parse the at least one second data packet based on the second indication and/or process the target data set based on the second indication and the transmission status of the reference data set.

In some embodiments, the information of the reference data set is determined by the first core network device based on the information of the data set sequence. The information of the data set sequence comes from the second core network device, and the data set sequence includes the reference data set and the target data set.

In some embodiments, the information of the data set sequence includes a sequence composed of the types or importance levels of data sets in the data set sequence.

In some embodiments, the information of the data set sequence further includes the time intervals of the data sets.

In some embodiments, the at least one first data packet originates from an application server or a peer terminal.

In some embodiments, the at least one first data packet is part of or all of the data packets of the target data set.

In some embodiments, the part of the data packets are specific data packets or data packets randomly selected from the target data set.

In some embodiments, the specific data packets are predefined or device-configured.

In some embodiments, the information of the reference data set includes at least one of: the identifier of the reference data set or the association information between the reference data set and the target data set.

In some embodiments, the association information is the spacing information between the reference data set and the target data set.

In some embodiments, one or more reference data sets are defined.

In some embodiments, the at least one second data packet further includes the identifier of the target data set.

In some embodiments, the target data set includes video frames or coded slices.

In some embodiments, the at least one second data packet is acquired by adding the information of the reference data set to the GTP packet header of the at least one first data packet.

In some embodiments, the processing unit 1420 is specifically configured to: discard the reference data set and/or the target data set in response to determining that the reference data set fails to be transmitted correctly based on the transmission status of the reference data set.

In some embodiments, the communication unit is a communication interface or a transceiver, or an input-output interface of a communication chip or system on chip. The above processing unit includes one or more processors.

It should be understood that the access network device according to the embodiments of the present disclosure may correspond to the access network device in the method embodiments, and the above and other operations and/or functions of the various units in the access network device are respectively for implementing the corresponding processes of the access network device in the method embodiments. For brevity, details are not described herein any further.

FIG. 15 is a schematic diagram of a terminal device 1500 according to some embodiments of the present disclosure. The terminal device 1500 includes a processing unit 1510. The processing unit 1510 is configured to: determine the information of a reference data set for a target data set; determine the transmission status of the reference data set based on the information of the reference data set; and process the target data set based on the transmission status of the reference data set.

In some embodiments, the target data set includes at least one first data packet, and the information of the reference data set is determined by the terminal device based on the application layer packet header information of the at least one first data packet.

In some embodiments, the application layer packet header information of the at least one first data packet includes the information of the reference data set.

In some embodiments, the at least one first data packet is part of or all of the data packets of the target data set.

In some embodiments, the part of the data packets are specific data packets or data packets randomly selected from the target data set.

In some embodiments, the specific data packets are predefined or device-configured.

In some embodiments, the terminal device 1500 further includes a communication unit 1520, configured to receive an indication message from the core network device; correspondingly, the processing unit 1510 is specifically configured to: determine the information of the reference data set for the target data set based on the indication message and/or process the target data set based on the indication message and the transmission status of the reference data set.

In some embodiments, the information of the reference data set includes at least one of: the identifier of the reference data set or the association information between the reference data set and the target data set.

In some embodiments, the association information is the spacing information between the reference data set and the target data set.

In some embodiments, one or more reference data sets are defined.

In some embodiments, the target data set includes video frames or coded slices. In some embodiments, the processing unit 1510 is specifically configured to: discard the reference data set and/or the target data set in response to determining that the reference data set fails to be transmitted correctly based on the transmission status of the reference data set.

In some embodiments, the above communication unit is a communication interface or a transceiver, or an input-output interface of a communication chip or system on chip. The above processing unit includes one or more processors.

It should be understood that the terminal device according to the embodiments of the present disclosure may correspond to the terminal device in the method embodiments, and the above and other operations and/or functions of the various units in the terminal device are respectively for implementing the corresponding processes of the terminal device in the method embodiments. For brevity, details are not described herein any further.

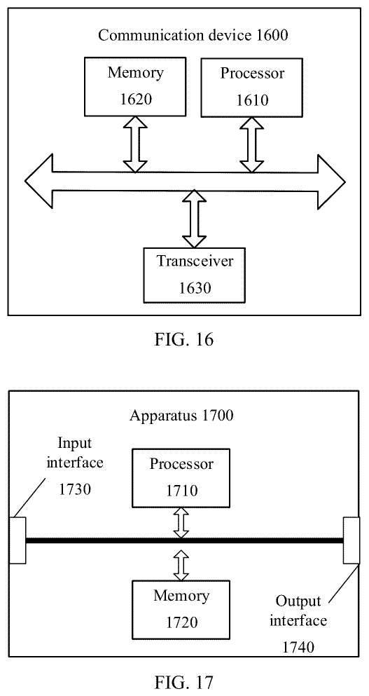

FIG. 16 is a schematic structural diagram of a communication device 1600 according to some embodiments of the present disclosure. The communication device 1600 shown in FIG. 16 includes a processor 1610. The processor 1610, when loading and running one or more computer programs from a memory, is caused to perform the methods in the embodiments of the present disclosure.

In some embodiments, as shown in FIG. 16, the communication device 1600 further includes a memory 1620. The processor 1610, when loading and running one or more computer programs from the memory 1620, is caused to perform the methods according to the embodiments of the present disclosure.

The memory 1620 is a separate device independent from the processor 1610 or is integrated within the processor 1610.

In some embodiments, as shown in FIG. 16, the communication device 1600 further includes a transceiver 1630. The processor 1610 controls the transceiver 1630 to communicate with other devices, specifically, to transmit information or data to other devices, or to receive information or data from other devices.

The transceiver 1630 includes a transmitter and a receiver. The transceiver 1630 further includes one or more antennas.

In some embodiments, the communication device 1600 is the core network device in the embodiments of the present disclosure, and the communication device 1600 performs the corresponding processes performed by the first core network device in the various methods according to the embodiments of the present disclosure. For brevity, details are not described herein any further.

In some embodiments, the communication device 1600 is the access network device in the embodiments of the present disclosure, and the communication device 1600 performs the corresponding processes performed by the access network device in the various methods according to the embodiments of the present disclosure. For brevity, details are not described herein any further.

In some embodiments, the communication device 1600 is the terminal device in the embodiments of the present disclosure, and the communication device 1600 performs the corresponding processes performed by the terminal device in the various methods according to the embodiments of the present disclosure. For brevity, details are not described herein any further.

FIG. 17 is a schematic structural diagram of an apparatus 1700 according to some embodiments of the present disclosure. The apparatus 1700 shown in FIG. 17 includes a processor 1710. The processor 1710, when loading and running one or more computer programs from a memory, is caused to perform the methods according to the embodiments of the present disclosure. In some embodiments, as shown in FIG. 17, the apparatus 1700 further includes a memory

1720. The processor 1710, when loading and running one or more computer programs from the memory 1720, is caused to perform the methods in the embodiments of the present disclosure.

The memory 1720 is a separate device independent from the processor 1710 or is integrated within the processor 1710.

In some embodiments, the apparatus 1700 further includes an input interface 1730. The processor 1710 controls the input interface 1730 to communicate with other devices or chips, specifically, to acquire information or data from the other devices or chips.

In some embodiments, the apparatus 1700 further includes an output interface 1740. The processor 1710 controls the output interface 1740 to communicate with other devices or chips, specifically, to output information or data to the other devices or chips.

In some embodiments, the apparatus is applicable to the network device in the embodiments of the present disclosure, and the apparatus performs the corresponding processes performed by the network device in the various methods according to the embodiments of the present disclosure. For brevity, details are not described herein any further.

In some embodiments, the apparatus is applicable to the terminal device in the embodiments of the present disclosure, and the apparatus performs the corresponding processes performed by the terminal device in the various methods according to the embodiments of the present disclosure. For brevity, details are not described herein any further.

In some embodiments, the apparatus d in the embodiments of the present disclosure is a chip. For example, the apparatus may be a system-level chip, a system chip, a chip system, a system-on-chip, and the like.

It should be understood that the processor in the embodiments of the present disclosure may be an integrated circuit chip capable of processing signals. During the implementation, each process in the foregoing method embodiments may be performed by an integrated logic circuit of hardware in the processor or by using instructions in a form of software. The processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The processor can implement or execute the methods, processes, and logical block diagrams according to the embodiments of the present disclosure. The general-purpose processor may be a microprocessor, any conventional processor, or the like. The processes of the methods according to the embodiments of the present disclosure may be directly performed by a hardware decoding processor, or performed by a combination of hardware and software modules in the decoding processor. The software module may be disposed in a mature storage medium in the art, such as a random access memory (RAM), a flash memory, a read-only memory (ROM), a programmable ROM (PROM), an electrically erasable programmable memory, or a register. The storage medium is disposed in a memory. The processor reads information in the memory, and performs the processes of the foregoing methods in combination with hardware in the processor.

It can be understood that the memory in the embodiments of the present disclosure may be a volatile memory or a non-volatile memory, or may include both a volatile memory and a non-volatile memory. The non-volatile memory may be a ROM, a PROM, an erasable PROM (EPROM), an electrically EPROM (EEPROM), or a flash memory. The volatile memory may be a RAM, used as an external cache. By way of example but not limitation, RAMs of many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM). It should be noted that the memory involved in the systems and methods described herein is intended to include, but is not limited to, these memories and a memory of any other suitable type.

It should be understood that the foregoing description of the memory is exemplary but not for limitation. For example, the memory in the embodiments of the present disclosure may alternatively be an SRAM, a DRAM, an SDRAM, a DDR SDRAM, an ESDRAM, an SLDRAM, or a DR RAM. That is, the memory in the embodiments of the present disclosure is intended to include, but not be limited to, these and any other suitable types of memory.

The embodiments of the present disclosure further provide a computer-readable storage medium configured to store one or more computer programs.

In some embodiments, the computer-readable storage medium is applicable to the network device or base station in the embodiments of the present disclosure. The one or more computer programs, when loaded and run by a computer, cause the computer to perform the corresponding processes performed by the network device or base station in methods according to the embodiments of the present disclosure. For brevity, details are not described herein any further.

In some embodiments, the computer-readable storage medium is applicable to the mobile terminal or terminal device in the embodiments of the present disclosure. The one or more computer programs, when loaded and run by a computer, cause the computer to perform the corresponding processes performed by the mobile terminal or terminal device in methods according to the embodiments of the present disclosure. For brevity, details are not described herein any further.

The embodiments of the present disclosure further provide a computer program product including one or more computer program instructions.

In some embodiments, the computer program product is applicable to the network device or base station in the embodiments of the present disclosure. The one or more computer program instructions, when loaded and executed by a computer, cause the computer to perform the corresponding processes performed by the network device or base station in methods according to the embodiments of the present disclosure. For brevity, details are not described herein any further.

In some embodiments, the computer program product is applicable to the mobile terminal or terminal device in the embodiments of the present disclosure. The one or more computer program instructions, when loaded and executed by a computer, cause the computer to perform the corresponding processes performed by the mobile terminal or terminal device in methods according to the embodiments of the present disclosure. For brevity, details are not described herein any further.

The embodiments of the present disclosure further provide a computer program.

In some embodiments, the computer program is applicable to the network device or base station in the embodiments of the present disclosure. The computer program, when loaded and run by a computer, causes the computer to perform the corresponding processes performed by the network device or base station in methods according to the embodiments of the present disclosure. For brevity, details are not described herein any further.

In some embodiments, the computer program is applicable to the mobile terminal or terminal device in the embodiments of the present disclosure. The computer program, when loaded and run by a computer, causes the computer to perform the corresponding processes performed by the mobile terminal or terminal device in methods according to the embodiments of the present disclosure. For brevity, details are not described herein any further.

Those of ordinary skill in the art may understand that, in combination with the examples described in the embodiments disclosed herein, units and algorithm processes may be implemented by electronic hardware or a combination of computer software and electronic hardware. Whether the functions are performed by hardware or software depends on specific applications and design constraints of the technical solutions. Those skilled in the art may implement the described functions in different ways for each specific application, but such implementation should not be considered beyond the scope of the present disclosure.

Those skilled in the art clearly understand that for convenience and brevity of description, and for specific working processes of the systems, apparatuses, and units described above, reference may be made to corresponding processes in the method embodiments. Details are not described herein any further.

In the several embodiments of the present disclosure, it should be understood that the disclosed systems, apparatuses, and methods may be implemented in other manners. For example, the described apparatus embodiments are merely examples. For example, division of the units is merely logical function division and may be other division in actual implementation. For example, a plurality of units or components may be combined or integrated into another system, or some features may be omitted or not performed. In addition, the displayed or discussed mutual couplings or direct couplings or communication connections may be implemented over some interfaces. The indirect couplings or communication connections between the apparatuses or units may be implemented in electrical, mechanical, or other forms.

The units described as separate parts may be or may not be physically separate, and parts displayed as units may be or may not be physical units, may be disposed in one position, or may be distributed on a plurality of network units. Some or all of the units may be selected based on actual requirements to achieve the objectives of the solutions according to the embodiments.

In addition, functional units in the embodiments of the present disclosure may be integrated into one processing unit, each of the units may exist alone physically, or two or more units are integrated into one unit.

The functions may be stored in a computer-readable storage medium in the case that they are implemented in a form of a software functional unit and sold or used as a standalone product.

Based on such an understanding, the technical solutions of the present disclosure essentially, or the part contributing to the prior art, or some of the technical solutions may be implemented in a form of a software product. The computer software product is stored in a storage medium, and includes instructions for causing a computer device (which may be a personal computer, a server, a network device, or the like) to perform all or some of the processes of the methods described in the embodiments of the present disclosure. The storage medium includes any medium capable of storing program code, such as a universal serial bus (USB) flash disk, a mobile hard disk, a ROM, a RAM, a magnetic disk, or an optical disk.

The above descriptions are merely specific implementations of the present disclosure, but the protection scope of the present disclosure is not limited thereto. Any variation or replacement readily derived by those skilled in the art within the technical scope of the present disclosure shall fall within the protection scope of the present disclosure. Therefore, the protection scope of the present disclosure should be subject to the protection scope of the claims.

What is claimed is:

1. A method for wireless communication, applicable to a first core network device, the method comprising:
determining information of a reference data set for a target data set, wherein the target data set comprises at least one first data packet;
acquiring at least one second data packet by adding the information of the reference data set to a packet header other than an Internet Protocol (IP) packet header of the at least one first data packet; and
transmitting the at least one second data packet to an access network device.

2. The method according to claim 1, further comprising:
receiving a first indication from a second core network device;
wherein determining the information of the reference data set for the target data set comprises: determining the information of the reference data set based on the first indication; or
wherein acquiring the at least one second data packet by adding the information of the reference data set to the packet header other than the IP packet header of the at least one first data packet comprises: acquiring the at least one second data packet by adding the information of the reference data set to the packet header other than the IP packet header of the at least one first data packet based on the first indication.

3. The method according to claim 1, wherein acquiring the at least one second data packet by adding the information of the reference data set to the packet header other than the IP packet header of the at least one first data packet comprises:
acquiring the at least one second data packet by adding the information of the reference data set to a general packet radio service (GPRS) Tunnelling Protocol (GTP) packet header of the at least one first data packet.

4. The method according to claim 1, wherein determining the information of the reference data set for the target data set comprises:
determining the information of the reference data set based on application layer packet header information of the at least one first data packet, wherein the application layer packet header is a Real-time Transport Protocol (RTP) packet header.

5. The method according to claim 1, wherein the information of the reference data set comprises at least one of: an identifier of the reference data set or association information between the reference data set and the target data set.

6. The method according to claim 1, wherein the target data set comprises video frames or coded slices.

7. The method according to claim 1, wherein the first core network device is a user plane function (UPF).

8. The method according to claim 1, wherein the at least one first data packet comprises a data packet on an N6 interface.

9. A core network device, wherein the core network device is a first core network device, and the core network device comprises:
a processor; and
a memory storing one or more computer programs, which, when executed by the processor, cause the core network device to:
determine information of a reference data set for a target data set, wherein the target data set comprises at least one first data packet;
acquire at least one second data packet by adding the information of the reference data set to a packet header other than an Internet Protocol (IP) packet header of the at least one first data packet; and
transmit the at least one second data packet to an access network device.

10. The core network device according to claim 9, wherein the one or more computer programs, when executed by the processor, further cause the core network device to:
receive a first indication from a second core network device; and
the core network device is further caused to:
determine the information of the reference data set based on the first indication; or
acquire the at least one second data packet by adding the information of the reference data set to the packet header other than the IP packet header of the at least one first data packet based on the first indication.

11. The core network device according to claim 9, wherein the one or more computer programs, when executed by the processor, further cause the core network device to:
acquire the at least one second data packet by adding the information of the reference data set to a general packet radio service (GPRS) Tunnelling Protocol (GTP) packet header of the at least one first data packet.

12. The core network device according to claim 9, wherein the one or more computer programs, when executed by the processor, further cause the core network device to:
determine the information of the reference data set based on application layer packet header information of the at least one first data packet, wherein the application layer packet header is a Real-time Transport Protocol (RTP) packet header.

13. The core network device according to claim 9, wherein the information of the reference data set comprises at least one of: an identifier of the reference data set or association information between the reference data set and the target data set.

14. The core network device according to claim 9, wherein the target data set comprises video frames or coded slices.

15. The core network device according to claim 9, wherein the first core network device is a user plane function (UPF).

16. The core network device according to claim 9, wherein the at least one first data packet comprises a data packet on an N6 interface.

17. A core network device, wherein the core network device is a second core network device, and the core network device comprises:
a processor; and
a memory storing one or more computer programs, which, when executed by the processor, cause the core network device to:
transmit a first indication to a first core network device;
wherein the first indication is used for the first core network device to:
determine information of a reference data set for a target data set based on the first indication; or
acquire at least one second data packet by adding the information of the reference data set to a packet header other than an Internet Protocol (IP) packet header of at least one first data packet based on the first indication.

18. The core network device according to claim 17, wherein the information of the reference data set comprises at least one of: an identifier of the reference data set or association information between the reference data set and the target data set.

19. The core network device according to claim 17, wherein the target data set comprises video frames or coded slices.

20. The core network device according to claim 17, wherein the second core network device is a session management function (SMF).
